(19) United States
(12) Patent Application Publication
(10) Pub. No.: US 2015/0100430 A1
(43) Pub. Date: Apr. 9, 2015

(54) LEAD OR CONSUMER RELATIONSHIP DEVELOPMENT

(71) Applicant: Zurple, Inc., Carlsbad, CA (US)

(72) Inventors: Ryan Owen, San Diego, CA (US); Thomas Owen, San Diego, CA (US)

(73) Assignee: Zurple, Inc., Carlsbad, CA (US)

(21) Appl. No.: 14/072,555

(22) Filed: Nov. 5, 2013

Related U.S. Application Data
(60) Provisional application No. 61/887,257, filed on Oct. 4, 2013.

(51) Int. Cl. G06Q 30/02; G06Q 50/16

(52) U.S. Cl. CPC G06Q 30/0269; G06Q 50/16
USPC 705/14.66

(57) ABSTRACT

An example method comprises monitoring actions of a user of an online service; detecting a triggering of an event; identifying information relevant to the event and associated with the user, the identifying being based at least in part on the monitored actions of the user; and generating an auto-message to the user providing the user with the information.

### RELATED APPLICATION

This application claims the benefit of co-pending U.S. Provisional Application Ser. No. 61/887,257, filed on Oct. 4, 2013, which is related to U.S. application Ser. No. 12/828,172, filed on Jun. 30, 2010, and titled “LEAD GENERATION AND UTILIZATION”, which is hereby incorporated by reference in its entirety for all purposes.

### FIELD OF THE INVENTION

The present invention relates generally to the field of sales and marketing. More particularly, the present invention relates to facilitating the development of leads or enhancement of consumer relationships.

### BACKGROUND

The proliferation of on-line services has facilitated a variety of transactions between the buyers, sellers and other associated parties such as advertisers, agents, brokers and other intermediaries. In case of a real estate transaction, a buyer may simply log into, or otherwise access, a website that contains a number of listings in order to search for his or her desired real estate property. Such websites typically allow a buyer to narrow the search by specifying the desired property characteristics, such as the price range, square footage, number of rooms, zip code and other criteria. The buyer is then presented with a number of properties that meet the specified search criteria. Similarly, a seller of a property may list a property using an online service to make it available for viewing by hundreds or even thousands of potential buyers or renters.

Real estate agents have also benefited from the proliferation of real estate on-line services because companies that operate the on-line services often connect their website visitors with real estate agents and sales associates. The real estate agent or sales associate may, for example, place advertisements on the pages that contain the on-line listings. The agent or sales associate may also pay a subscription fee or a fee per lead to the on-line service for receiving leads (contact details of potential customers). Such leads are usually based on the information submitted by the consumers during the registration process. For example, a user of an on-line service may be prompted to provide contact information and desired property specifications so that he/she can be contacted by a real estate agent or receive email updates when new properties are listed that meet the user's search criterion. The agents may also restrict the received leads to correspond to properties within certain zip codes, price ranges and other characteristics. The on-line service then matches the incoming leads with the agent's preferences, and provides the matched leads to the appropriate agents and sales associates.

### SUMMARY OF THE INVENTION

The disclosed embodiments of the present invention relate to devices, methods, and computer program products that may develop a lead or to enhance a relationship with a lead or a consumer.

### BRIEF DESCRIPTION OF THE FIGURES

Embodiments of the invention are described by referring to the attached drawings, in which:

FIG. 1 illustrates the various components associated with various examples;

FIG. 2 illustrates a flow chart for monitoring of user actions in accordance with various examples;

FIG. 3 illustrates a flow chart for developing or enhancing a relationship with a user in accordance with various example;

FIG. 4 illustrates a flow chart for developing or enhancing a relationship with a user in accordance with another example; and

FIG. 5 illustrates an example device within which the various embodiments may be implemented.

### DETAILED DESCRIPTION OF CERTAIN EMBODIMENTS

In the following description, for purposes of explanation and not limitation, details and descriptions are set forth in order to provide a thorough understanding of the present invention. However, it will be apparent to those skilled in the art that the present invention may be practiced in other embodiments that depart from these details and descriptions.

In various examples, devices, methods, and computer program products are provided that may automate the identification, selection, development or enhancement of relationships with various users, including sales leads, such as those generated from a real estate online service or imported from an existing sales lead database. Relationships may be developed or enhanced by monitoring and/or recording the behavior of the users as they use online service(s), such as websites, web apps, or mobile apps. Data from various sources, such as real estate property and listings data may be analyzed. Further, in various examples, personal information provided by either the clients (e.g., agents) or the users may also be analyzed. The analysis of the various information may be used to automatically detect useful, notable, relevant, or important events relevant to the user. Using the recorded and/or derived data, the devices, methods, and computer program products may automatically alert clients (e.g., agents) of the identified event and/or user, providing indications and details of the behavior and motivations of the user, as well as suggested actions the client should take. Further, messages may be automatically generated (e.g., selected from a database of messages) that are relevant, personal, and timely to the user in a manner such that the messages seem to be written by a human being.

As noted earlier, on-line real estate services often produce a volume of leads that make it difficult for a subscribing real estate agent or sales associate to efficiently sort through and respond to or follow up with potential customers or leads in a timely and effective manner. To overcome these obstacles, the agent is thus faced with a two-fold task. First, the agent needs a solution to identify which of the many leads is most likely to represent ureal buyer or seller in the near future so that the agent can best maintain the relationship with that lead, concentrate his/her attention on that lead and ultimately convert the lead into a sale. Second, the agent needs to communicate with a great volume of leads in the most specific manner possible because specific communication is more likely to be opened, read and responded to by consumers, whereas generic communication is generally deleted by consumers or marked as spam.

In various exampled described herein, the terms customers, consumers, leads, clients and users are used to describe users of the system that may be purchasers, sellers, potential purchasers or potential sellers, for example. The terms customers, consumers, leads, clients and users are used interchangeably herein. Further, in various examples, the users may be potential leads (e.g., a first-time interaction) or may be past relations (e.g., past buyers or sellers of property that have interacted in the past with the system and/or the agent).

Traditional lead generation methods also produce a large number of leads based on an initial snapshot of consumer interests that are not updated based on the consumers' ongoing behavior and updated interests. In high-valued transactions with long sales cycles, the consumers often conduct additional searches and/or make further refinements to their initial selections. For example, a real estate consumer may return to an on-line real-estate service to narrow the price range, modify the neighborhoods that are being searched or fine-tune additional search criteria, over the course of a long sales cycle.

The disclosed embodiments improve and facilitate communication with a user to, for example, produce a high-quality relationship between the agent and the user. The user may be, for example, a lead or a current client.

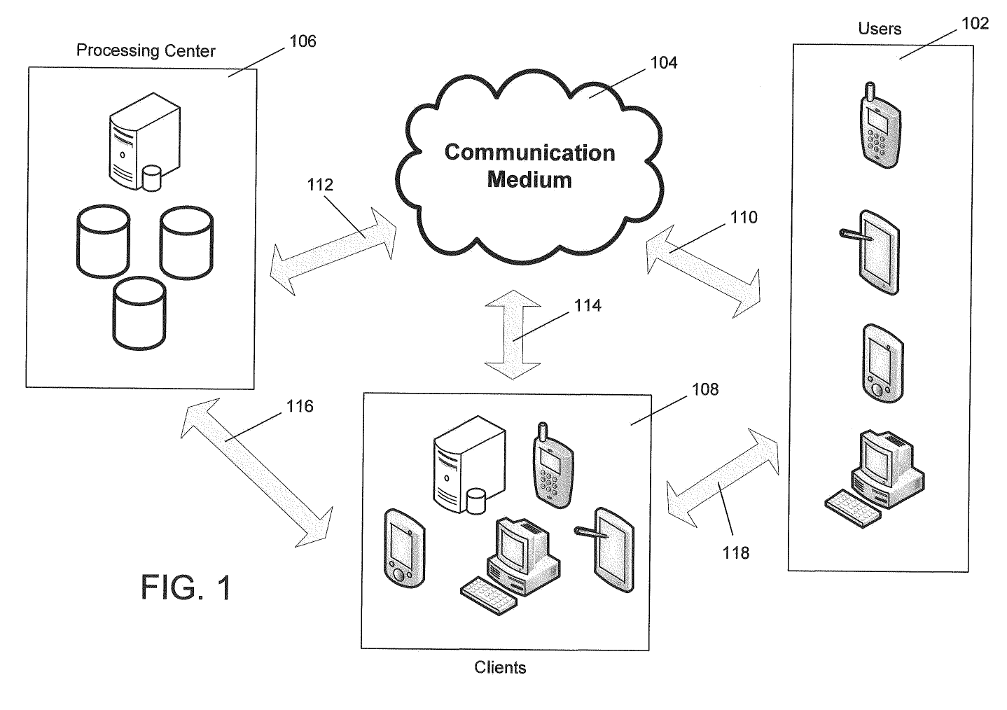

FIG. 1 illustrates the various components and entities associated with the various disclosed embodiments. The illustrated components and entities are presented for example purposes only, and it should be understood that more or fewer devices, entities or connections may be used for implementing the various disclosed embodiments. The right-hand-side of FIG. 1. depicts the users 102 of an on-line service, such as a real estate on-line service. The users 102 may utilize various devices to access the on-line listings and services. Such devices include, but are not limited to, personal and laptop computers and handheld devices, such as cell phones, smart phones, personal digital assistants (PDAs) and tablet devices. It should be noted that the term “user” or “consumer” refers to individuals, entities and/or devices that access the on-line services to search for listed products or services, list their own product or service and/or to conduct other transactions related to the products or services. Non-exhaustive examples of users 102 include consumers that use the on-line services to locate real estate properties that are listed for sale, lease or rent, as well as consumers that use the on-line services to list properties for sale, lease or rent. The users 102 are typically allowed free access to the on-line services and are often required to provide information, such as contact email, address and/or phone numbers, at some point during their interactions with the on-line service website. The users 102, in some cases, may also be required to pay a subscription fee in exchange for services they obtain from the on-line service.

The on-line services may allow access to different types of properties and services. In the on-line real estate service example, the properties can include residential, commercial, industrial and/or other types of property listings, as well as associated websites, databases and services. An example real estate listing may include property specifications that are represented in text, picture and/or video formats. Such listings often allow a user who conducts a property search to specify the desired property characteristics, such as price range, address, zip code, square footage, number of rooms and the like. A user can thus search for and obtain a list of the desired properties. Such listings may, for example, be obtained through Multiple Listing Service (MLS) database. A typical web page associated with the on-line services may also include advertisements and/or information associated with one or more real estate agents, lenders, contractors or other persons or entities promoting their products or services. In some variations, the on-line services may be incorporated into the website of a particular real estate professional.

Referring back to FIG. 1, the users 102 may access the on-line services through a communication medium 104 that, directly or indirectly, connects the users 102, the clients (e.g., agents) 108 and the on-line services and/or the processing center 106. For example, the communication medium may comprise the Internet. The users 102 may be connected to the communication medium 104 through a link 110 that can utilize a variety of communication interfaces and protocols. For example, the users 102 may use wired or wireless communication protocols to connect to the communication medium 104. FIG. 1 also illustrates the clients 108 of the on-line services that are connected to the communication medium 104 through the link 114. The link 114 to the communication medium 104 can be established through a variety of communication interfaces and protocols. The client 108 may also be connected to the users 102 through a link 118, which, for example, represents a secure connection. The clients 108 may be subscribers of the on-line service and can include, but not limited to, agents, brokers, sales associates and other professionals that participate and/or facilitate the sales transaction. For example, in the real estate example scenario, the clients may be real estate brokers, agents, and like, or alternatively, the clients may be property owners (e.g., large home builders that act as their own real estate agents). In a non-real estate scenario, the clients may similarly include brokers, intermediaries and/or owners of the properties that are being listed on-line. Alternatively, the clients can be employers, employment seekers, recruiters or other professionals that are seeking to acquire, render or facilitate the transactions related to employment/service contracts. The clients 108 may also be allowed to place advertisements and/or to create personalized websites that incorporate some or all of the services and/or utilities that are provided by the on-line services. The clients 108 can access the on-line services through a variety of devices including, but not limited to, personal and laptop computers, handheld devices, such as cell phones, smart phones, PDAs and tablet devices and the like. FIG. 1 also illustrates a link 116 through which the clients 108 may be able to directly interact with the processing center 106. The link 116 may, for example, represent a secure connection between the clients 108 and the processing center 106.

The processing center 106 of FIG. 1 is connected to the communication medium 104 through the link 112. The link 112 to the communication medium 104 can be established through a variety of communication interfaces and protocols. The processing center 106 is responsible for interacting with the users 102, obtaining various information provided by the users 102, tracking and recording various activities of the users 102, and generating various alerts to the users 102 and/or to the clients 108. The processing center 106 may also host and maintain all or part of the services and features of the real estate on-line services. As depicted in FIG. 1 for illustration purposes, the processing center 106 may comprise one or more servers, one or more databases and/or other data storage media that can be used for storing various data, as well as software code for implementing the disclosed embodiments. However, it should also be noted that some of the devices and/or software code for carrying out the various operations of the processing center 106 may reside outside of the processing center 106. Additionally, or alternatively, such operations may be carried out in a distributed fashion among multiple processing centers and/or peer devices.

In an example scenario, a user of the on-line services may log into, or otherwise access, an on-line real estate services website. A new user may initially be asked to provide certain identification information, such as name, email address, phone number, mailing address and the like. The user may then start using the on-line services. For example, a user may browse a number of property listings in a particular neighborhood in order to evaluate, and perhaps ultimately purchase, a listed property. Before any purchase, however, a user often returns to the on-line service's website to expand or narrow the search premises, view additional properties and/or revisit some of the properties that he/she has already viewed. It is unlikely that while in this investigatory phase, the user intends to receive unsolicited phone calls or emails from a real estate agent or broker. From a client's (e.g., an agent or sales associate) perspective, making initial or follow-through personal contact with the user, e.g., through emails and phone calls, may only be worthwhile if the user has exhibited a certain amount of interest in a property or neighborhood. Further, as noted above, since a large number of users may access the on-line services, the client can become inundated with a large volume of leads and lead information that must be further analyzed to determine the value (e.g., the level of interest or price point) of the generated leads.

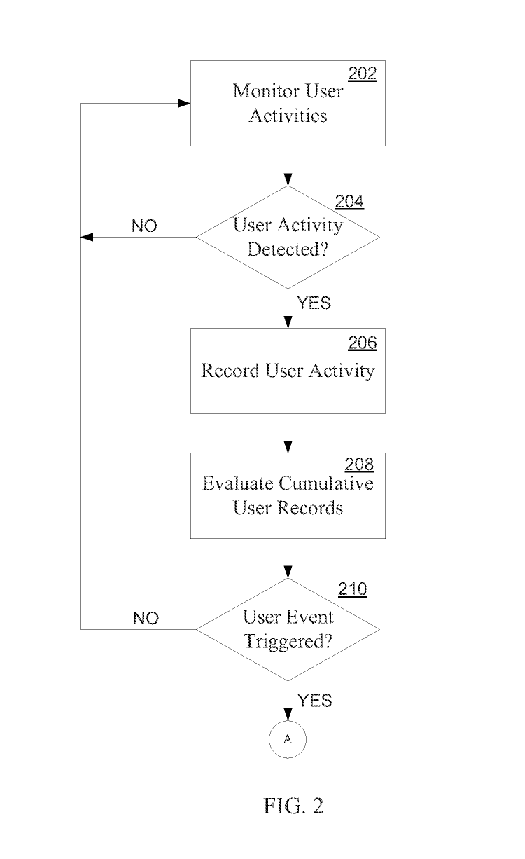

Referring now to FIG. 2, an example flow chart for monitoring of user actions is illustrated. In the illustrated example, the activities of a user of the real estate on-line services are monitored (block 202). The monitoring may include, but is not limited to, collecting information related to the number of times a user has visited the website, the particular properties that the user has viewed, the number of times a particular property has been viewed, the price range, square footage and location (e.g., zip code, street name, etc.) of the viewed properties and the like. In various examples, the user activity may include the saving of a particular property of a set of properties to a “Favorites” list by the user.

At block 204, it is determined whether or not a user activity has occurred. If no user activity is detected (“NO”), the process returns to block 202 to continue monitoring user activities. If a user activity is detected (“YES”), the procedure continues to block 206, where the user activity is recorded. Such a recording may, for example, comprise storing one or more of the following: a description of the activity (or a code that identifies that activity), the identity of the user, the identity of an associated client and the like. At block 208, the cumulative record associated with the user is evaluated. For example, such cumulative record may include all recorded activities associated with the user since the delivery of the last intelligent auto responder to that user. In some examples, the cumulative record may comprise all activities ever recorded for that user and/or all activities of the user since a given date (e.g., in the last month). Such records may also include additional information that may have been obtained from the user (e.g., during the initial registration process, after the registration process, through comments on on-line forums, etc.), as well as information added to the records by the client. In still other examples, the cumulative record may include information added to the profile of the user by the system. For example, the system may acquire demographic information for the user from various other sources (e.g., public records, social media networks, etc.). Such information may include birthday, leisure activities, charitable interests, etc.

At block 210, it is determined whether a user-related event has been triggered. As described below, a user-related event may be triggered based on certain actions of the user, whether an individual action or a cumulative record of actions.

In various examples, an event may be triggered by comparing accumulated user activities to predetermined metrics that, for example, demonstrate information of particular interest to the user. Further, an event may be triggered when a user designates a particular property as his/her favorite property by marking the property as a “Favorite”. As further examples, events may be triggered if the user views a particular property for the fifth time in a month or searches for properties above a certain price.

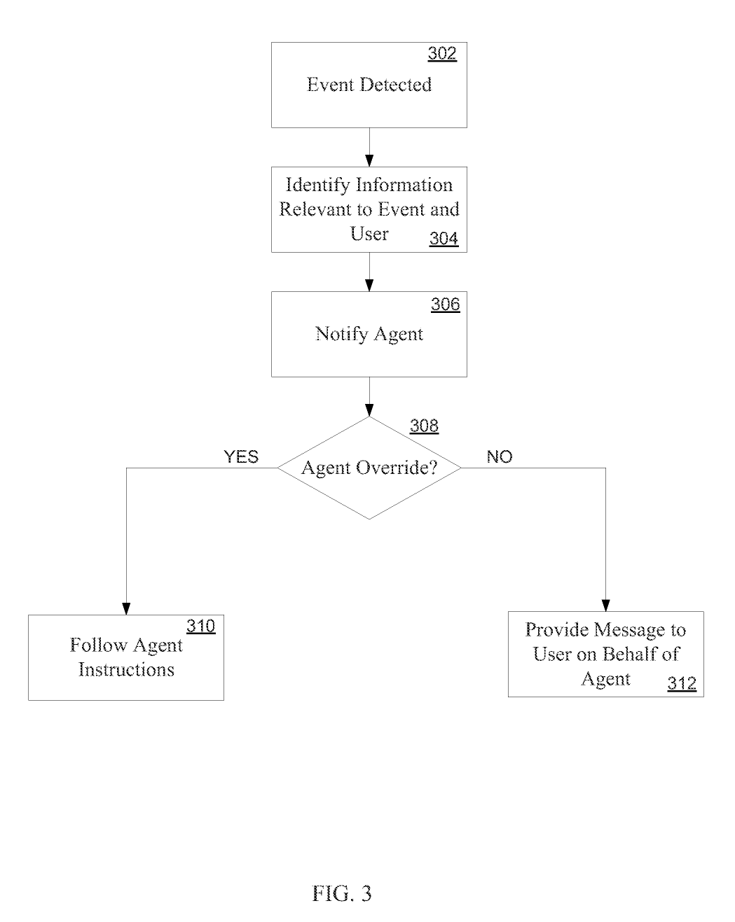

If the event triggering criteria is not satisfied (“NO”), the process returns to block 202 to continue monitoring user activities. If, on the other hand, an event triggering criteria is satisfied (“YES”), a lead communication process may be launched. One example of a lead communication process is illustrated in FIG. 3.

Referring now to FIG. 3, a flow chart illustrates an example process for developing or enhancing a relationship with a user, such as a lead. In accordance with the example process, an event may be detected (block 302). In various examples, an event may be detected as described above with reference to FIG. 2 based on, for example, an evaluation of user activity and/or records. In various examples, an event may also be triggered by satisfaction of various other criteria, such as the update of a database (e.g., a database of sales or listings) or actions of others associated with the system. For example, an event may be triggered based on viewing of a particular property by numerous users (e.g., “most viewed property”).

In one example, an event may be triggered without any activity by the user. For example, account information for a user may be added or updated by another use or a system administrator. The account information may include an address associated with the user, and the system may identify a real-estate event based on the address. For example, a property in the neighborhood may be listed for sale. The system may use this to trigger an event.

In another example, the system may detect the closing of a sale of a property in the geographic area of a user's property. The system may trigger an event if the closing price of the property sold is significantly higher than the average price in the area.

Upon detection of an event, the system may identify information relevant to the event or the user (block 304). In this regard, the system may generate a message to be delivered to the user on behalf of an agent. Various examples of relevant information and generated messages associated with various events are provided below.

The system may notify the agent associated with the event (block 306), informing the agent of the detected event and the message to be sent to the user. The agent may be provided with the option to override the system (block 308), thereby preventing the generated message from being sent to the user. If the agent overrides the generated message, the system follows the agent's instructions (block 310). For example, the system may allow the agent to modify the generated message, delete the message, or send the message to various other users. If, on the other hand, the agent does not override the generated message, the system provides the message to the user on behalf of the agent.

In various examples, the message is an automatically generated message that may be structured to appear as if written in a personalized manner by an individual.

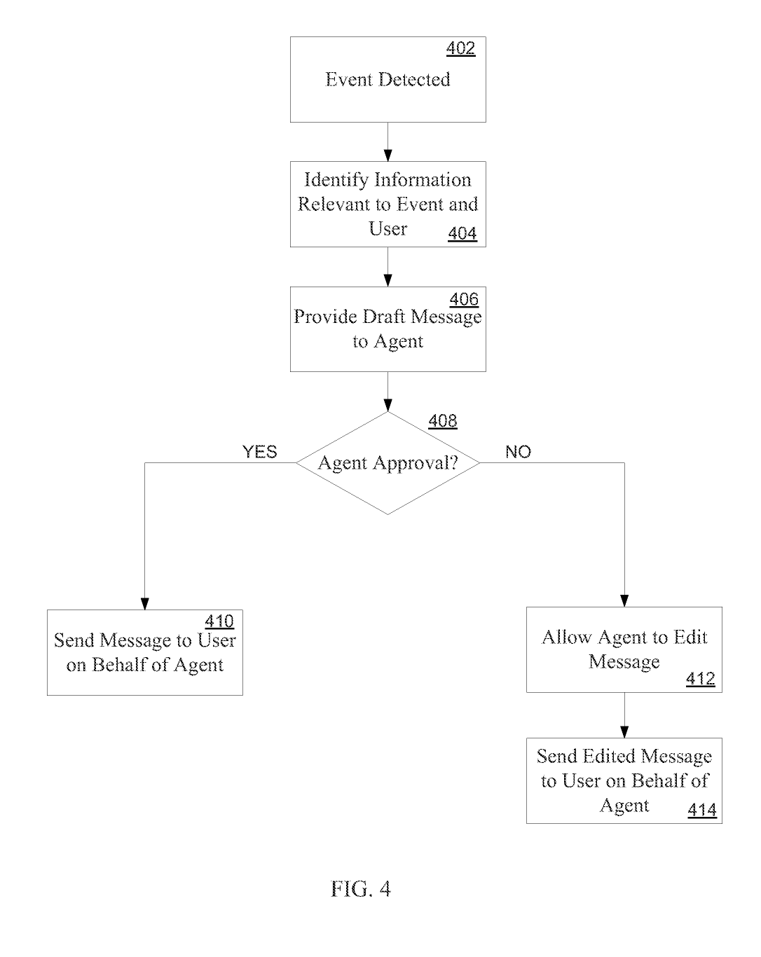

Referring now to FIG. 4, a flow chart illustrates another example process for developing or enhancing a relationship with a user, such as a lead. In accordance with the example process, similar to the example process of FIG. 3 described above, an event may be detected (block 402). As noted above, in various examples, an event may be detected as described above with reference to FIG. 2 based on, for example, an evaluation of user activity and/or records. In various examples, an event may also be triggered by satisfaction of various other criteria, such as the update of a database (e.g., a database of sales or listings) or actions of others associated with the system.

Upon detection of an event, the system may identify information relevant to the event or the user (block 404). Various examples of relevant information and generated messages associated with various events are provided below.

The system may provide a draft of the message to the agent associated with the event (block 406). The draft message may be accompanied by an indication of the detected event to notify the agent of the origin of the draft message. The agent may be provided with the option to approve the draft message (block 408). If the agent approves the message, the message is sent to the user on behalf of the agent (block 410). Otherwise, the agent may be provided the opportunity to edit the message (block 412), and the edited message is then sent to the user on behalf of the agent (block 414). Of course, the agent may elect that the message not be sent to the user and may be provided with the option to delete the draft message (not shown in FIG. 4).

Thus, the system is able to monitor a user's on-line behavior to detect possible desires or preferences of the user. The system can also use data analytics, such as information that may be gathered or generated from information in a database (e.g., a real-estate database of sales and listings). In this regard, various forms of data analytics may be performed to identify information that may be of interest to various users (e.g., agents, buyers, sellers, etc.). For example, data analytics may be used to identify trends in various communities. The system can then identify information that may be of interest to the user and provide the information to the user on behalf of an agent. In various examples, the agent may be an individual or a real estate related company, such as a national real estate portal. Thus, the system may be useful in improving or deepening the relationship between the user and the agent. In some examples, the system can identify information that may be of interest to the user and provide the information directly to the agent so that the agent can provide the information in a manual way to the particular user.

The following provides various examples of events and associated messages which may be sent to the user. In these examples, the field %{lead_first}% represents the user (e.g., potential buyer or seller), %{search_city}% represents the city that is the focus of user's search, %{rep_first}% represents a particular client of the online services (e.g., a real estate agent), %{prop_city}% represents the city in which the property is located, %{prop_address}% represents the address at which the property is located and %{site_url}% represents the link to a particular website.

In one example, an event may be generated upon a regular (e.g., monthly) update of a database of recently listed or sold properties. The generated message may be targeted to users that may be potential property sellers and may include:
Hi %{lead_first}%,
Here is your monthly community real estate update. The following nearby <<lead's property type>> s, that closely match the characteristics of your <<lead's property type>>, were listed for sale or were sold in the past month. Please let me know if you have any questions about the state of the <<lead's property city>> real estate market or if I can help you with any of your real estate needs.
%{rep_first}%.

In another example, an event may be generated upon the listing of a property similar to a property or types of properties of interest (e.g., in a particular neighborhood) to a user. The generated message may be targeted to users that may be potential property sellers and may include:
Hi %{lead_first}%,
I thought you'd be interested to know that a <<property type>> on <<listed property address>> was listed for sale on <<listing date>>. The property is <<square footage>> square feet and is listed at <<current listing price>>. This puts its price per square foot at <<price per square foot>>, which is <<above, same, below>> the average square foot sold price for <<neighborhood/community>> over the past 6 months. Let me know if you have any questions about the state of the <<lead's property city>> real estate market or if I can help you with any of your real estate needs.
%{rep_first}%.

In another example, an event may be generated upon the sale of a property similar to a property or types of properties of interest (e.g., in a particular neighborhood) to a user. The generated message may be targeted to users that may be potential property sellers and may include:
Hi %{lead_first}%,
I thought you'd like to know that a <<sold property's property type>> near yours recently sold <<above, same, below>> the asking price of <<last listing price>>. The <<sold property's property type>> is located on <<sold property's address>> and was on the market for <<days on market>> days. Are there any questions about the <<neighborhood/community>> real estate market that I can answer for you?
%{rep_first}%.

In another example, an event may be generated upon the sale of a property similar to a property or types of properties of interest (e.g., in a particular neighborhood) to a user. The generated message may be targeted to users that may be potential property buyers and may include:
Hi %{lead_first}%,
Just wanted to let you know that a <<sold property's property type>>, that closely matches your property preferences, was recently sold <<above, same, below>> the asking price of <<last listing price>>. The <<sold property's property type>> is located on <<sold property's address>> and was on the market for <<days on market>> days. Are there any questions about the <<neighborhood/community>> real estate market that I can answer for you?
%{rep_first}%.

In another example, an event may be generated upon the saving of a property to a “Favorites” folder by a user. The generated message may be targeted to users that may be potential property buyers and may include:
Hi %{lead_first}%,
Since you saved <<property address>> to favorites, I thought you'd be interested to know that the listing price <<increased or decreased>> from <<previous listing price>> to <<current listing price>>. If you're still interested in the property, now might be a good time to see it in person. Let me know if I can show you the property.
%{rep_first}%.

In another example, an event may be generated upon the increase of a price of a property for sale in a neighborhood of interest to a user. The generated message may be targeted to users that may be potential property sellers and may include:
Hi %{lead_first}%,
I thought you'd find this interesting since this property is close to yours. A <<property type>> on <<listed property address>> was recently listed for sale on <<listing date>> at <<current listing price>>. The property is <<square footage>> square feet making its price per square foot at <<price per square foot>>, which is <<above, same, below>> the average square foot sold price for <<neighborhood/community>> over the past 6 months. Let me know if you have any questions about the state of the <<lead's property city>> real estate market or if I can help you with any of your real estate needs.
%{rep_first}%.

In another example, an event may be generated when an offer is made on a property that is in the “Favorites” folder of a user. The generated message may be targeted to users that may be potential property buyers and may include:
Hi %{lead_first}%,
I thought you'd like to know that <<property address>>, which you saved to favorites, is now contingent. Contingent means it has an accepted offer but the final sale is subject to the buyer meeting certain requirements, such as getting financing. If you are still interested in the property, you can make a “backup offer” in case the current offer isn't completed. Would you like me to help you make a backup offer?
%{rep_first}%.

In another example, an event may be generated when a property that is in the “Favorites” folder of a user has been on the market for a particular number of days (e.g., an excessive number of days). The generated message may be targeted to users that may be potential property buyers and may include:
Hi %{lead_first}%,
I thought you'd like to know that <<property address>> has been on the market significantly longer than average for <<neighborhood/community>>. If you are still interested in the property, I can try to learn how motivated the seller is. Let me know if you'd like me to find out.
%{rep_first}%.

In another example, an event may be generated based on an update of a database indicating how many times a property has been viewed by various users. The message may indicate the most popular (e.g., most viewed) properties that match a user's preferences. The generated message may be targeted to users that may be potential property buyers and may include:
Hi %{lead_first}%,
Below is a list of the properties that match your property preferences and that have been viewed the most on my website. I thought you might also be interested in these properties. Let me know if you want more information about any of them.
%{rep_first}%.

In another example, an event may be generated when a property matching a user's preferences is sold above a listing price. The generated message may be targeted to users that may be potential property buyers and may include:
Hi %{lead_first}%,
I thought you would like to know that the following properties, that match your property preferences, recently sold above their listing prices. In aggregate, <<property type matching lead's property preferences>> in <<neighborhood/community>> have sold <<X %>> over their original listing price in the past 6 months. Let me know if you want more information about the <<neighborhood/community>> market.
%{rep_first}%.

In another example, an event may be generated when a property near a user's property is sold above a listing price. The generated message may be targeted to users that may be potential property sellers and may include:
Hi %{lead_first}%,
<<property type matching lead's property>>, on average, have sold <<X %>> above their original listing prices in the past 6 months in <<neighborhood/community>>. Below is a list of some properties that recently sold over their original listing prices in <<neighborhood/community>>. I thought you'd find this information interesting. Let me know if you'd like more information about market conditions in <<neighborhood/community>>.
%{rep_first}%.

In another example, an event may be generated when property trends of interest to the user are identified. The trends may be identified based on, for example, update of a database or the analysis of a user's preferences. The generated message may be targeted to users that may be potential property buyers and may include:
Hi %{lead_first}%,
I thought you might find the following price trends of <<property type>> in <<neighborhood/community>> interesting since you have been searching for properties there. Let me know if you'd like more information about market conditions in <<neighborhood/community>>.
%{rep_first}%.

In another example, an event may be generated when property trends of interest to the user are identified. The trends may be identified based on, for example, update of a database or the analysis of a user's preferences. The generated message may be targeted to users that may be potential property sellers and may include:
Hi %{lead_first}%,
Just wanted to let you know of the price trends of <<property type>> in <<neighborhood/community>> since your home is located there. Let me know if you'd be interested in a home valuation report for your home.
%{rep_first}%.

In another example, an event may be generated when the inventory of available properties decreases. The event may be identified based on the update of a database, for example. The generated message may be targeted to users that may be potential property sellers and may include:
Hi %{lead_first}%,
Inventory levels for <<property type>> are <<X %>> below historical levels in <<neighborhood/community>>. If you've been considering selling your home, now may be a good time to list to not only sell quickly but to also get a price above what you might expect. Let me know if you'd be interested in a price analysis report for your home.
%{rep_first}%.

In another example, an event may be generated when the inventory of available properties decreases. The event may be identified based on the update of a database, for example. The generated message may be targeted to users that may be potential property buyers and may include:
Hi %{lead_first}%,
Inventory levels for <<property type>> in <<neighborhood/community>> are <<X %>> below historical levels and inventory levels are likely to continue to be tight for the next few months. Let me know if you would like me to show you any properties in <<neighborhood/community>>. I may also have some pocket listings (properties not on the MLS) that may be of interest to you.
%{rep_first}%.

In another example, an event may be generated when the inventory of available properties increases. The event may be identified based on the update of a database, for example. The generated message may be targeted to users that may be potential property buyers and may include:
Hi %{lead_first}%,
Inventory levels for <<property type>> in <<neighborhood/community>> are <<X %>> above historical levels. Since there are a lot of choices, sellers may be willing to be flexible on their prices. I have a list of homes that I think would interest you, can I show these to you in the next few days?
%{rep_first}%.

In another example, an event may be generated on a particular schedule (e.g., weekly, monthly, etc.) to indicate one or more users viewed the listings of the particular agent. The generated message may be targeted to the particular agent and may include a listing of all users and properties viewed by the users.

In another example, an event may be generated when a user saves one or more listings of the particular agent to a “Favorites” folder. The generated message may be targeted to the particular agent and may include a listing of all users and properties saved to the “Favorites” folder.

In another example, an event may be generated based on a user's visiting an agent's website. The event may be identified based on the actions of the user, for example. The generated message may be targeted to users that may be potential property buyers and may include:
Hi %{lead_first}%,
I've noticed you've been visiting my site, saving properties, and opening listing alert emails frequently in the past 30 days. What is your purchasing timeline (you can tell me here)? How can I help you in your search?
%{rep_first}%.

In another example, an event may be generated based on a user's saving of a property to a “Favorites” folder for which the agent is the listing agent. The generated message may be targeted to users that may be potential property buyers and may include:
Hi %{lead_first}%,
I noticed you saved <<saved to favorites property>> to favorites. I thought you'd like to know that I'm the listing agent for the property, and as such, I have a lot of inside information about it. Are you available for a quick call later today so I can update you?
%{rep_first}%.

In another example, an event may be generated based on a user's saving of a property to a “Favorites” folder and for which the property has a low listing price per square foot. The generated message may be targeted to users that may be potential property buyers and may include:
Hi %{lead_first}%,
Since you saved <<saved to favorites property address>>, I thought you'd like to know that its <<current listing price per square foot>> listing price per square foot is <<percentage>> lower than average for <<city>>? Are you looking for bargain properties? I also know of other similar properties.
%{rep_first}%.

In another example, an event may be generated based on a user's saving of a property to a “Favorites” folder and for which the property has a high listing price per square foot. The generated message may be targeted to users that may be potential property buyers and may include:
Hi %{lead_first}%,
I saw that you saved <<property address>> to favorites and wanted you to know that its current listing price per square foot is <<percentage>> higher than average for <<city>>. Would you like to know more details about why its price per square foot is so high?
%{rep_first}%.

In another example, an event may be generated based on the identification of a user as a frequent browser on the system. The event may be triggered based on the user's behavior, such as visiting the site a certain number of times in a certain time period, saving a minimum number of properties to the “Favorites” folder, or opening of a certain number of property update emails. The triggering of the event may also take into consideration the user's profile, such as the user's address. The generated message may be targeted to users that may be potential property sellers and may include:
Hi %{lead_first}%,
You are an active user on my site. I was wondering, as part of your home buying process, are you also considering selling <<lead's property address>>? You can let me know by replying to this email or letting me know here.
%{rep_first}%.

In another example, an event may be generated based on the user's behavior of searching properties different than saved property preferences. The generated message may be targeted to users that may be potential property buyers and may include:
Hi %{lead_first}%,
I noticed that you've been viewing properties that have different attributes than what I've been providing you in my property listing update emails. If you update your property preferences, (you can do that here) or if you reply to this email so I can update your preferences, I can make some great recommendations for properties that fit your new preferences.
%{rep_first}%.

In another example, an event may be generated based on the user's behavior of searching properties in a location that is different than saved property preferences. The generated message may be targeted to users that may be potential property buyers and may include:
Hi %{lead_first}%,
Just curious if you are now more interested in properties in <<new city>> rather than <<property preference city>>, which is used for your listing update emails. I noticed that you've been viewing many more properties in <<new city>> than in <<property preference city>> in the last 30 days. You can change your search location preference here or reply to this email so I can update your preferences. Either way, I can provide you some great recommendations for properties in <<new city>>.
%{rep_first}%.

In another example, an event may be generated based on the user's behavior of searching properties built in years that are different than saved property preferences. The generated message may be targeted to users that may be potential property buyers and may include:
Hi %{lead_first}%,
I've been seeing that your most recent searches are for properties that are at least 10 years newer than what you have saved in your search preferences. Are you interested in newer properties? Let me know by updating your year built preference (you can do that here) or by replying to this email so I can update this preference. I know of good properties in either age range.
%{rep_first}%.

In another example, an event may be generated based on the user's behavior of searching properties that are larger in square footage than saved property preferences. The generated message may be targeted to users that may be potential property buyers and may include:
Hi %{lead_first}%,
With your recent searches, you've been searching for properties that are larger than what is saved in your search preferences. Just wondering if you're now considering properties with more square footage? I know of some really nice properties in the larger square footage range. Let me know how I can help. Also, please update your square footage preferences (you can do that here) or reply to this email and I can update this preference.
%{rep_first}%.

In another example, an event may be generated based on the user's behavior of searching properties that are smaller in square footage than saved property preferences. The generated message may be targeted to users that may be potential property buyers and may include:
Hi %{lead_first}%,
I see your recent searches are for properties smaller than what you have saved in your search preferences. Are you considering smaller properties? If you'd like, I can provide you some recommendations in that square footage range, let me know. Also, please update your square footage preferences (you can do that here) or reply to this email and I can update this preference.
%{rep_first}%.

In another example, an event may be generated when a user saves a property to his “Favorites” folder and the property is contingent. The generated message may be targeted to users that may be potential property buyers and may include:
Hi %{lead_first}%,
I thought you would like to know that <<saved to favorites property>>, that you saved to favorites, is now “contingent”, which means it has an accepted offer. Most of the time, contingent properties end up being sold. Would you like me to let you know if this property ends back on the market or let you know of similar properties that are still for sale?
%{rep_first}%.

In another example, an event may be generated when a property in the user's “Favorites” folder returns to market from a contingent status. The generated message may be targeted to users that may be potential property buyers and may include:
Hi %{lead_first}%,
I wanted to let you know that <<saved to favorites property>> is back on the market at <<listing price>>, which is a <<lower, same, higher>> price than before. It's back on the market because the previous offer and contract wasn't completed. Are you still interested in this property? Now might be a good time to see it in person. Let me know if I can help.
%{rep_first}%.

In another example, an event may be generated when a property in the user's “Favorites” folder is taken off the market. The generated message may be targeted to users that may be potential property buyers and may include:
Hi %{lead_first}%,
Just wanted to let you know that <<saved to favorites property>>, that you saved to favorites, is off the market. There can be a number of reasons why. Would you like me to find out why or let you know of similar properties that are still for sale?
%{rep_first}%.

In another example, an event may be generated when the user's behavior indicates a preference for properties with large lot sizes. The event may be triggered if, for example 80 percent of the user's searches or clicks are for properties on lots of over one acre. The generated message may be targeted to users that may be potential property buyers and may include:
Hi %{lead_first}%,
Are you interested in properties with large lots? If so, what is the lot size range you're looking for? I can recommend several properties with large lot sizes.
%{rep_first}%.

In another example, an event may be generated when the user's behavior indicates a preference for properties with large garages. The event may be triggered if, for example 80 percent of the user's searches or clicks are for properties with at least three-car garages or if the user includes three-car garage in an advanced search criteria. The generated message may be targeted to users that may be potential property buyers and may include:
Hi %{lead_first}%,
I've noticed that recently you've been viewing properties that have at least a three-car garage. Is this a primary property criterion for you? I can help you in your search for properties with three-car and larger garages.
%{rep_first}%.

In another example, an event may be generated when the user's behavior indicates a preference for single-story homes. The event may be triggered if, for example 80 percent of the user's searches or clicks are for properties that are single story. The generated message may be targeted to users that may be potential property buyers and may include:
Hi %{lead_first}%,
I see you're mostly viewing one-story homes on my site. Are you mostly interested in one-story homes? Also, let me know what other qualities you're looking for and I'm sure I can help you find the perfect home.
%{rep_first}%.

In another example, an event may be generated when the user's behavior indicates a preference for properties with a pool. The event may be triggered if, for example, 80 percent of the user's searches or clicks are for properties that include a swimming pool or if the user is mostly saving properties (e.g., 80 percent of saved properties) to favorites that have a pool. The generated message may be targeted to users that may be potential property buyers and may include:
Hi %{lead_first}%,
Are you looking for homes with their own pools? I was thinking you were because I noticed that you've been viewing several properties on my site with pools. There are several properties with pools in <<search location city>> that I think you might like. Let me know if you want to learn more about them.
%{rep_first}%.

In another example, an event may be generated when the user's behavior indicates a preference for properties that are newly constructed. The event may be triggered if, for example 80 percent of the user's searches or clicks are for properties that are new construction or if the user indicates property age must be in the last five years in their search criteria. The generated message may be targeted to users that may be potential property buyers and may include:
Hi %{lead_first}%,
Are you primarily interested in new construction? I thought you might because I noticed you've been viewing newer properties on my site. I also wanted to let you know that brand new construction is often not listed on MLS sites, but I can provide you details of brand new construction properties that you might be interested in. Let me know how I can help.
%{rep_first}%.

In another example, an event may be generated when the user's behavior indicates a preference for properties that are in a specific neighborhood. The event may be triggered if, for example 80 percent of the user's searches or clicks are for properties in the same neighborhood or community. The generated message may be targeted to users that may be potential property buyers and may include:
Hi %{lead_first}%,
There are several nice properties currently for sale in <<neighborhood/community>>. Is this your prime target area for purchasing a home? I thought it might be because the homes you've been viewing recently on my site are mostly in <<neighborhood/community>>. If interested, I can provide you demographic and economic info on <<neighborhood/community>> as well as keep you informed of opportunities that I hear about before they hit the MLS.
%{rep_first}%.

In another example, an event may be generated when the user's behavior indicates a preference for properties that have an ocean view. The event may be triggered if, for example 80 percent of the user's searches or clicks are for properties with an ocean view or if the user indicates such a preference in their search criteria or if the user mostly saves homes to favorites that have an ocean view. The generated message may be targeted to users that may be potential property buyers and may include:
Hi %{lead_first}%,
I see that you've been looking at properties on my site that have ocean views. How close to the ocean would you like to be? I know of several properties of varying distance from the ocean but that have nice ocean views.
%{rep_first}%.

In another example, an event may be generated when the user's behavior indicates a preference for properties that have a lake view. The event may be triggered if, for example 80 percent of the user's searches or clicks are for properties with a lake view. The generated message may be targeted to users that may be potential property buyers and may include:
Hi %{lead_first}%,
I noticed that you are looking at properties on my site that have lake views. Do you want a property right on a lake?
%{rep_first}%.

In another example, an event may be generated when the user's behavior indicates a preference for properties that have a river view. The event may be triggered if, for example 80 percent of the user's searches or clicks are for properties with a river view. The generated message may be targeted to users that may be potential property buyers and may include:
Hi %{lead_first}%,
I see that you are looking at properties on my site that have river views. Are you interested in a property right on the river?
%{rep_first}%.

In another example, an event may be generated when the user's behavior indicates a preference for properties that have a water view. The event may be triggered if, for example 80 percent of the user's searches or clicks are for properties with a water view. The generated message may be targeted to users that may be potential property buyers and may include:
Hi %{lead_first}%,
I noticed that you are viewing properties on my site that have water views. Do you prefer properties on the water? I know of a few properties that you might be interested in.
%{rep_first}%.

In another example, an event may be generated when the user's behavior indicates a preference for properties that have a city view. The event may be triggered if, for example 80 percent of the user's searches or clicks are for properties with a city view. The generated message may be targeted to users that may be potential property buyers and may include:
Hi %{lead_first}%,
I was wondering if you prefer properties with city views? I've noticed that you are primarily looking at properties on my site that have city views. There are several properties on the market that I think you might like.
%{rep_first}%.

In another example, an event may be generated when the user's behavior indicates a preference for properties that have a mountain view. The event may be triggered if, for example 80 percent of the user's searches or clicks are for properties with a mountain view. The generated message may be targeted to users that may be potential property buyers and may include:
Hi %{lead_first}%,
Are you searching for a property with a mountain view? I was wondering since most of the properties you've viewed recently on my site have mountain views. Let me know, I can recommend several nice properties.
%{rep_first}%.

In another example, an event may be generated when the user's behavior indicates a preference for properties that have a view of a golf course. The event may be triggered if, for example 80 percent of the user's searches or clicks are for properties with a golf-course view. The generated message may be targeted to users that may be potential property buyers and may include:
Hi %{lead_first}%,
Are you a golfer? I thought you might be since I noticed you have been viewing mostly properties on my site that have golf course views. Let me know, there are many nice properties that I can recommend.
%{rep_first}%.

In another example, an event may be generated when the user's behavior indicates a preference for properties with a community golf course. The event may be triggered if, for example 80 percent of the user's searches or clicks are for properties with a community golf course. The generated message may be targeted to users that may be potential property buyers and may include:
Hi %{lead_first}%,
Do you golf? I see that you've been mostly viewing properties that have a community golf course. There are several properties that I can recommend, let me know if you prefer a property right on the course.
%{rep_first}%.

In another example, an event may be generated when the user's behavior indicates a preference for properties with community tennis courts. The event may be triggered if, for example 80 percent of the user's searches or clicks are for properties with community tennis courts. The generated message may be targeted to users that may be potential property buyers and may include:
Hi %{lead_first}%,
Do you play tennis? I see that you've been mostly viewing properties on my site that have community tennis courts. I know of several properties for sale with nice community tennis courts.
%{rep_first}%.

In another example, an event may be generated when the user's behavior indicates a preference for properties with horse facilities. The event may be triggered if, for example 80 percent of the user's searches or clicks are for properties with horse facilities. The generated message may be targeted to users that may be potential property buyers and may include:
Hi %{lead_first}%,
Just wondering if you have horses because I've noticed that you've been viewing properties on my site with horse facilities. Let me know because I know of a few properties that might work for you.
%{rep_first}%.

In another example, an event may be generated when the user's behavior indicates a preference for properties in senior communities. The event may be triggered if, for example 80 percent of the user's searches or clicks are for senior community properties. The generated message may be targeted to users that may be potential property buyers and may include:
Hi %{lead_first}%,
I noticed that you've been viewing properties in senior communities from my site. Can I help you find a senior community with the amenities you are looking for?
%{rep_first}%.

In another example, an event may be generated when the user's behavior indicates a preference for properties with community parks. The event may be triggered if, for example 50 percent of the user's searches or clicks are for properties with community parks. The generated message may be targeted to users that may be potential property buyers and may include:
Hi %{lead_first}%,
I noticed that you've been viewing properties in neighborhoods with community parks from my site. I know of several nice properties in great neighborhoods with community parks. Can I help you find a property that fits your needs?
%{rep_first}%.

In another example, an event may be generated when the user's behavior indicates a preference for properties with boating facilities. The event may be triggered if, for example 50 percent of the user's searches or clicks are for properties with boating facilities. The generated message may be targeted to users that may be potential property buyers and may include:
Hi %{lead_first}%,
Just wondering if you have a boat because I've noticed that you've been viewing properties on my site that have boating facilities. Let me know because I know of a few properties that might work for you.
%{rep_first}%.

In another example, an event may be generated when the user's behavior indicates a preference for properties with community security. The event may be triggered if, for example 50 percent of the user's searches or clicks are for properties that have community security. The generated message may be targeted to users that may be potential property buyers and may include:
Hi %{lead_first}%,
I noticed that you have been searching for properties on my site that have community security, for example, a gated community. Is this a top priority for you? I know of several nice properties in different neighborhoods that I think you might like.
%{rep_first}%.

In another example, an event may be generated when the user's behavior indicates a preference for properties with disability features. The event may be triggered if, for example 50 percent of the user's searches or clicks are for properties that have disability features. The generated message may be targeted to users that may be potential property buyers and may include:
Hi %{lead_first}%,
I wanted to reach out to you because I noticed that you have been searching for properties on my site that have disability features. These properties can be difficult to find but I can help you find the property with the disability features you're looking for. Let me know if you'd like my help.
%{rep_first}%.

In another example, an event may be generated when the user's behavior indicates a preference for properties in a cul-de-sac. The event may be triggered if, for example 50 percent of the user's searches or clicks are for properties located in a cul-de-sac. The generated message may be targeted to users that may be potential property buyers and may include:
Hi %{lead_first}%,
I see you've been viewing properties on my site that are located in cul-de-sacs. Is this one of the primary attributes you're looking for in a home? I know of many nice properties in cul-de-sacs that I think would interest you. Let me know if you want more details about them.
%{rep_first}%.

In another example, an event may be generated when the user's behavior indicates a preference for properties on a corner lot. The event may be triggered if, for example 50 percent of the user's searches or clicks are for properties located on a corner lot. The generated message may be targeted to users that may be potential property buyers and may include:
Hi %{lead_first}%,
Just wondering if a home on a corner lot is important to you because I've noticed you've been viewing properties on my site that are on corner lots. I have a few properties on corner lots that I can recommend and that I think you'll like. Let me know if you want more details.
%{rep_first}%.

In another example, an event may be generated when the user's behavior indicates a preference for properties with recreational vehicle (RV) or boat parking. The event may be triggered if, for example 50 percent of the user's searches or clicks are for properties with RV or boat parking. The generated message may be targeted to users that may be potential property buyers and may include:
Hi %{lead_first}%,
I was wondering if you have an RV or boat since you've been viewing properties that have RV/boat parking. These types of properties can be hard to find, let me know if you'd like me to help in your search.
%{rep_first}%.

In another example, an event may be generated when the user's behavior indicates a preference for properties with a basement. The event may be triggered if, for example 80 percent of the user's searches or clicks are for properties with a basement. The generated message may be targeted to users that may be potential property buyers and may include:
Hi %{lead_first}%,
I've noticed that you've been viewing mostly properties with basements from my site. Is this one of your top considerations in purchasing a home? Let me know, I have several properties in mind that I think would work for you.
%{rep_first}%.

In another example, an event may be generated when the user's behavior indicates a preference for properties with air conditioning. The event may be triggered if, for example 25 percent of the user's searches or clicks are for properties with air conditioning. The generated message may be targeted to users that may be potential property buyers and may include:
Hi %{lead_first}%,
I see you've been viewing mostly properties on my site that have air conditioning. Are you also looking for highly efficient air conditioning? Let me know, I have several properties in mind that I think would work for you.
%{rep_first}%.

In another example, an event may be generated upon the listing of an open house for a property which sufficiently matches the user's preferences. The event may be triggered if, for example, the open house has square footage within 20 percent of the user's preference and in a neighborhood of interest to the user. The generated message may be targeted to users that may be potential property buyers and may include:
Hi %{lead_first}%,
I thought you'd like to know of open houses this coming weekend for properties that match your search criteria. Let me know if you want more details about these properties or if you'd like me to join you in viewing them.
%{rep_first}%.

In another example, an event may be generated when the user's behavior indicates a sufficient interest in two or more neighborhoods. For example, the event may be triggered when the user views at least 5 properties in each of two or more neighborhoods within a 30-day period. The event may cause a message to be sent to the user providing the user with a comparison of certain features. The generated message may be targeted to users that may be potential property buyers. In one example, the message may provide the user with a comparison of property appreciation for the two or more neighborhoods. For example, the message may include:
Hi %{lead_first}%,
Since you've been viewing several <<property type> in <<search location 1>> and <<search location 2>>, I thought you'd like to know that the average sold price per square foot for <<property type>> in <<search location 1>> is <<search location 1 price per square foot>> and in <<search location 2>> it is <<search location 2 price per square foot>>. Also, <<property type>> prices have appreciated <<search location 1 appreciation %>> and <<search city 2 appreciation %>>, respectively in the past two years. I hope you find this information helpful in your home search and let me know if you have any questions about this data.
%{rep_first}%.

In other examples, the user may be provided with a price appreciation comparison of two or more particular properties of interest to the user. For example, the message may include:
Hi %{lead_first}%,
I noticed that you seem to favor <<property address 1>> and <<property address 2>> because you've viewed them several times on my website in the past couple days. I thought you'd like to know that <<property address 1>> has appreciated <<appreciation %>> and <<property address 2>> has appreciated <<appreciation %>> in the past two years. Let me know if you'd like more information about the properties.
%{rep_first}%.

In other examples, various other parameters may be compared between neighborhoods, types of neighborhoods (e.g., coastal versus inland, urban versus suburban) or types of properties (e.g., single-family homes versus condos). A user may be provided with comparisons of property appreciation, crime rates, quality of schools, or various other parameters. In other examples, the user may be provided with comparisons of two or more particular properties, whether in the same neighborhood or different neighborhoods. For example, the user may be provided with a comparison of the property appreciation of two or more properties for which the user may have clicked at least 3 times each.

The comparisons may also take the form of contrasting different search behavior by the same consumer so as to draw meaningful conclusions for the user and impact their future behavior. For example, if the user is looking at two and three bedroom condos and houses in two different communities, the system may identify which of the three parameters (bedrooms, property type, and community) has the greatest impact on asking price per square foot, and which historically has the largest appreciation trend associated with it. This information may be provided to the user, for example, through the agent. The user can use this knowledge to inform and modify search and purchase behavior.

In another example, an event may be generated by comparing a user's behavior to non-real estate data. For example, if the user is searching a mix of properties with and without a boat dock, the system may identify and provide to the user a study that illustrates the costs associated with boat ownership and a study demonstrating the relative happiness of boat owners with their purchase over a five-year period. In another example, if the user is searching in a particular school district, the user may be provided with a study showing SAT scores from the local high school or a list of prominent alumni from that school.

In another example, an event may be generated when the user's behavior indicates a preference for properties in neighborhoods or communities with a young median age. The event may be triggered if, for example, the neighborhood with the most property clicks by the user has a median age below 30 years old. The generated message may be targeted to users that may be potential property buyers and may include:
Hi %{lead_first}%,
I noticed that you've been searching properties in <<search location>> and was wondering if schools are an important criteria in your home search? If so, I know of several properties close to schools that I think might work for you. I can provide you a list of the properties and the school ratings.
%{rep_first}%.

In another example, an event may be generated when the user's behavior indicates a preference for properties in neighborhoods or communities identified as “booming”. The event may be triggered if, for example, the neighborhood with the most property clicks by the user, or a neighborhood with 10 or more property clicks within a 30-day period, has had a population increase of at least 25 percent in the last 10 years. The generated message may be targeted to users that may be potential property buyers and may include:
Hi %{lead_first}%,
<<search location>> has really experienced a boom in the past decade. The population has grown by <<% population increase>> and the median income has increased by <<% median income>> during the past 10 years. If you'd like more demographic, school info, etc. for <<search location>>, let me know and I'll provide it for you.
%{rep_first}%.

In another example, an event may be generated when the user's behavior indicates a sufficient interest in two or more neighborhoods and the user's profile indicates the user has a child under 18-years old. For example, the event may be triggered when the user views at least 5 properties in each of two or more neighborhoods within a 30-day period. The event may cause a message to be sent to the user providing the user with a comparison of schools in the two or more neighborhoods. The generated message may be targeted to users that may be potential property buyers and may include:
Hi %{lead_first}%,
I noticed that you've been clicking on properties in <<search location 1>> and <<search location 2>> and thought you'd like to know the school ratings for <<search location 1>> is <<school rating 1>> and for <<search location 2>> is <<school rating 2>>. Let me know if schools are an important consideration in your home search, I can recommend properties near good schools for any grade level.
%{rep_first}%.

In another example, an event may be generated when the user's behavior indicates a strong preference for a particular property. The event may be triggered if, for example, the user clicks on the same property ten times within a 5-day period. A message may be generated to offer the user a viewing of the property. The generated message may be targeted to users that may be potential property buyers and may include:
Hi %{lead_first}%,
I noticed that you've looked at <<property address>> several times on my website in the past couple days. Would you like to see it in person? Let me know what day and time works for you.
%{rep_first}%.

In another example, an event may be generated when a user frequently searches homes listed for sale and also owns a property in the same area. The generated message may be targeted to users that may be potential property sellers and may include:
Hi %{lead_first}%,
I happened to notice that your home address is located in the same general area where you're searching for homes. I was wondering whether, as part of your home buying process, you also need to sell your current home? I would love to tell you about the benefits of using me as your listing agent.
%{rep_first}%.

In another example, an event may be generated when a user frequently searches for properties listed for sale in an area where the agent has credible success metrics to share that match the area, such as active listings, reviews or testimonials from past clients, or historical closed transactions in the area. The generated message may be targeted to users that may be potential property buyers or sellers and may include:
Hi %{lead_first}%,
I happened to notice that you are primarily searching for homes in <<community/neighborhood>>. I would be honored to help you. I specialize in <<community/neighborhood>> and have <<9>> active listings there which I would be happy to discuss with you. So far this year I have closed << >> transactions in <<community/neighborhood>> and have received several positive reviews that I can share with you. Would you consider an introductory meeting so I can learn about your preferences and do my best to provide information that will be helpful to your search?
%{rep_first}%.

In another example, an event may be generated when a user frequently searches homes listed for sale and also has a property listed for sale. The message may provide the user with information relevant to the listed homes, such as price appreciation. The generated message may be targeted to users that may be potential property sellers and may include:
Hi %{lead_first}%,
Since I thought you may need to sell your current home as part of your home search, I thought you would be interested to know that <<lead's property type>> in <<city or neighborhood/community>> have appreciated <<appreciation %>> in the past two years. Let me know if you would like a home valuation report on your current home. You can request one here or by replying to this email.
%{rep_first}%.

In another example, an event may be generated when the user's behavior and/or profile indicate the user is a potential seller (e.g., has a home listed or has searched recent sales of similar homes). The messages may provide or offer to provide a variety of information that may be useful to a seller. For example, the generated message may include:
Hi %{lead_first}%,
I thought you'd find my “Costly Home Selling Mistakes” report useful because it's full of tips for helping you get a higher price for your home when you sell. Many of my clients have found it very helpful. You can request the free report here or by replying to this email.
%{rep_first}%.

In another example, the generated message may include:
Hi %{lead_first}%,
I noticed that your home search is in the same general area as your current home and I was wondering if you'll need to sell your current home? If so, I thought you'd might find my “Why ¾ of Home Sellers Don't get the Price They Want” report useful. Many of my clients have found it valuable. You can request the free report here or by replying to me through this email.
%{rep_first}%.

In another example, the generated message may include:
Hi %{lead_first}%,
I happened to notice that your home search is in the same general area as your current home and thought maybe you'll also need to sell your current home? If you will, I think you'll like the “10 High Cost Home Inspection Traps I Should Know Before Listing My Home” report. Many of my clients have found it very useful. You can request the free report here or by replying to me from this email.
%{rep_first}%.

In another example, the generated message may include:
Hi %{lead_first}%,
I thought you might also need to sell your current home since you've been viewing properties on my website that are in the same general area as your current home. I ran some analysis and properties in your market have appreciated <<appreciation %>> over the last 2 years and there are only <<number of listings>> active listings. It is a really good time to sell. Would you like to discuss an appropriate list price in the market today?
%{rep_first}%.

In another example, an event may be generated when the user's behavior and/or profile indicate the user is a potential seller (e.g., has a home listed or has searched recent sales of similar homes) and is searching for a larger home. The messages may provide or offer to provide a variety of information that may be useful to the user. For example, the generated message may include:
Hi %{lead_first}%,
I've been noticing that you are viewing mostly properties on my website that have more square footage than your current home. So, I thought you would be interested in the “5 Mistakes to Avoid When Moving to a Larger Home”. Many of my clients have found the report very informative. You can request the free report here or by replying to me through this email.
%{rep_first}%.

In another example, an event may be generated when the user's location indicates the user is visiting a city in which he has indicated an interest. For example, a user living in city A may have previously conducted searches for homes in city B. An event may be triggered when a geo-location data indicates the user is in the vicinity of city B. The messages may offer the user a viewing of various properties in city B. For example, the generated message may include:
Hi %{lead_first}%,
While you are in <<city B>>, would you like to view some properties that have recently come on the market? If you are interested, please contact me to schedule a viewing.
%{rep_first}%.

In another example, an event may be generated when the user's location indicates the user is in the vicinity of a property in which he has expressed an interest. For example, the user's geo-location may indicate that the user is within a block of a property the user has saved to his “Favorites” folder. For example, the generated message may include:
Hi %{lead_first}%,
While you are in the neighborhood, would you like to view one of your “Favorite” properties at <<property address>>? If you are interested, please contact me and I can arrange for you to view the property.
%{rep_first}%.

Of course, those skilled in the art will appreciate that other examples are possible and are contemplated within the scope of the present disclosure. The above list of examples is neither exhaustive nor limiting.

Further, while the above examples indicate various examples of triggering criteria for the various messages, those skilled in the art will appreciate that various other triggers may be used and are contemplated within the scope of the present disclosure. For example, various triggers may be based on an indication of a preference via saved properties to favorites or various searches conducted by the user.

As noted earlier, while the above examples describe an on-line service that relates to the real estate environment, the disclosed examples are equally applicable to other on-line environments associated with other products or services besides real estate.

The messages that are generated in accordance with the disclosed examples may include information produced by monitoring the actions of each user in real time and on a cumulative basis, by analyzing the collected information using rules and logic programmed into an analysis engine, and by enabling clients to augment the messages with additional information.

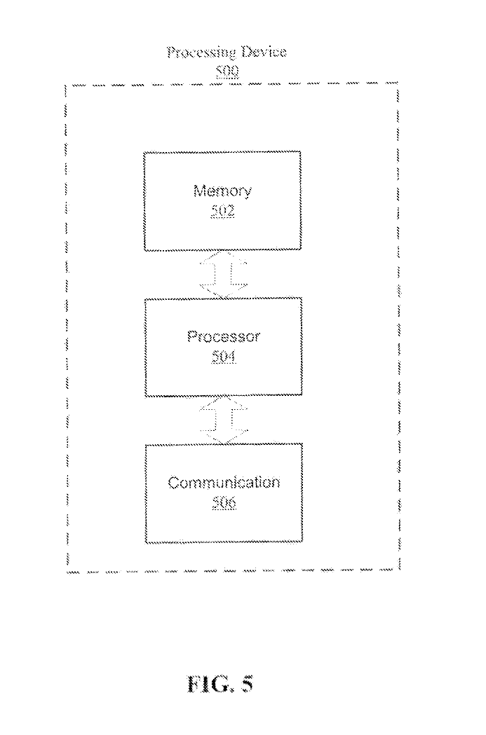

It is understood that the various embodiments of the present invention may be implemented individually, or collectively, in devices comprised of various hardware and/or software modules and components. These devices, for example, may comprise a processor, a memory unit, an interface that are communicatively connected to each other, and may range from desktop, server and/or laptop computers to consumer electronic devices such as mobile devices and the like. For example, FIG. 5 illustrates a block diagram of a device 500 within which the various embodiments of the present invention may be implemented. The device 500 comprises at least one processor 504 and/or controller, at least one memory unit 502 that is in communication with the processor, and at least one communication unit 506 that enables the exchange of data and information, directly or indirectly, with a communication medium, such as the Internet, or other entities and devices. The processor 504 can execute program code that is, for example, stored in the memory 502. The communication unit 506 may provide wired and/or wireless communication capabilities in accordance with one or more communication protocols and interfaces, and therefore it may comprise the proper transmitter/receiver antennas, circuitry and ports, as well as the encoding/decoding capabilities that may be necessary for proper transmission and/or reception of data and other information.

Similarly, the various components or sub-components within each module of the present invention may be implemented in software, hardware, and/or firmware. The connectivity between the modules and/or components within the modules may be provided using any one of the connectivity methods and media that is known in the art, including, but not limited to, communications over the Internet, wired, or wireless networks using the appropriate protocols.

Various embodiments described herein are described in the general context of methods or processes, which may be implemented in one embodiment by a computer program product, and embodied in a computer-readable medium, including computer executable instructions, such as program code, executed by computers in networked environments. A computer-readable medium may include removable and non-removable storage devices including, but not limited to, Read Only Memory (ROM), Random Access Memory (RAM), compact discs (COs), digital versatile discs (DVD), etc. As such, the various disclosed embodiments can be implemented by computer code embodied on nontransitory computer readable media. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes. In particular, the various steps that are described in the various block diagrams throughout this application are considered example, and it is understood that the steps may be performed in different order than what is shown. In addition, fewer or additional steps may be included.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

Furthermore, embodiments of the present invention may be implemented in software, hardware, application logic or a combination of software, hardware and application logic. The software, application logic and/or hardware may reside on a client device, a server or a network component. If desired, part of the software, application logic and/or hardware may reside on a client device, part of the software, application logic and/or hardware may reside on a server, and part of the software, application logic and/or hardware may reside on a network component. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may comprise a computer-readable storage medium that may be any media or means that can contain or store the instructions for use by or in connection with an instruction execution system, apparatus, or device, such as a computer. In one embodiment, the computer-readable storage medium is a non-transitory storage medium.

1. A method, comprising:
detecting, by a server associated with an online service, a triggering of an event;
identifying information relevant to the event and associated with a user of the online service; and
generating, in response to triggering of the event, an auto-message to the user providing the user with the information, wherein the auto-message is personalized for the user of the online service.

2. The method of claim 1, further comprising:
monitoring actions of the user on the online service,
wherein the identifying information relevant to the event is based at least in part on the monitored actions of the user.

3. The method of claim 1, wherein the message is an automatically generated message based on the event.

4. The method of claim 1, wherein the event is triggered by the actions of the user.

5. The method of claim 1, wherein the event is triggered by an update of a database associated with the online service.

6. The method of claim 5, wherein the information relevant to the event and associated with the user is based on data in the database associated with the online service.

7. The method of claim 1, wherein the online service is a real-estate service.

8. The method of claim 1, further comprising:
forwarding the auto-message to an agent associated with the user for approval.

9. A computer program product, embodied on a non-transitory computer readable medium, comprising:
computer code for detecting a triggering of an event;
computer code for identifying information relevant to the event and associated with a user of an online service; and
computer code for generating, in response to triggering of the event, an auto-message to the user providing the user with the information, wherein the auto-message is personalized for the user of the online service.

10. The computer program product of claim 9, further comprising:
computer code for monitoring actions of the user on the online service,
wherein the computer code for identifying information relevant to the event is based at least in part on the monitored actions of the user.

11. The computer program product of claim 9, wherein the message is an automatically generated message based on the event.

12. The computer program product of claim 9, wherein the event is triggered by the actions of the user.

13. The computer program product of claim 9, wherein the event is triggered by an update of a database associated with the online service.

14. The computer program product of claim 13, wherein the information relevant to the event and associated with the user is based on data in the database associated with the online service.

15. The computer program product of claim 9, wherein the online service is a real-estate service.

16. A device, comprising:
a processor;
a memory comprising processor executable code, the processor executable code, when executed by the processor, configures the device to:
monitor actions of a user of an online service;
detect a triggering of an event;
identify information relevant to the event and associated with the user, the identifying being based at least in part on the monitored actions of the user; and
generate, in response to triggering of the event, an auto-message to the user providing the user with the information, wherein the auto-message is personalized for the user of the online service.

17. The device of claim 16, wherein the message is an automatically generated message based on the event.

18. The device of claim 16, wherein the event is triggered by the actions of the user.

19. The device of claim 16, wherein the event is triggered by an update of a database associated with the online service.

20. The device of claim 19, wherein the information relevant to the event and associated with the user is based on data in the database associated with the online service.

21. The device of claim 16, wherein the online service is a real-estate service.
